(19) United States
(12) Patent Application Publication
(10) Pub. No.: US 2007/0198637 A1
(43) Pub. Date: Aug. 23, 2007

(54) Conferencing system with data file management

(76) Inventors: Scott Deboy, Hillsboro, OR (US); Kenneth Majors, Lake Oswego, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/649,675

(22) Filed: Jan. 3, 2007

Related U.S. Application Data
(60) Provisional application No. 60/756,412, filed on Jan. 4, 2006.

(51) Int. Cl. G06F 15/16

(52) U.S. Cl. 709/204

(57) ABSTRACT

By associating with a data file one or more descriptors that describe the data or specify access to the file, the data file management system facilitates locating and providing access to data files stored in a conferencing system.

### CROSS-REFERENCE TO RELATED APPLICATIONS

This application claims the benefit of U.S. Provisional Application No. 60/756,412, filed Jan. 4, 2006.

### BACKGROUND OF THE INVENTION

The present invention relates to a conferencing system and, more particularly, to a data file management system for a computer-based conferencing system.

Many activities are performed by teams of geographically dispersed individuals. For example, product design and manufacturing are commonly performed by teams having members who are often located in facilities spread around the globe and who may be in transit between locations. Similarly, a team, comprising educators at remotely located facilities, may be constituted to develop a new curriculum, policy or procedure for a school district or university. If a decision is to be made concerning a team activity it may be necessary to quickly review and edit documents, gather input and develop consensus regardless of the physical remoteness of the team members.

Modern communication technology enables communication over long distances and from remote locations and conferencing systems facilitate communication between multiple, remotely located conferees by enabling the conferees to communicatively interconnect with each other either directly as peers or by interconnecting with a central server that is, in turn, interconnected to the other participants in the conference. Computer-based conferencing systems provide audio and video communication between the conferees commonly enabling each participant to freely transmit video and/or audio to each of the other participants. On the other hand, the conferencing system may provide for designating one participant as the presenter and primary transmitter of video and/or audio while the other conferees listen and watch and with limited ability to transmit audio and video.

Conferences are enhanced by the inclusion of relevant graphic and textual input such as slide presentations, photographs, drawings, spreadsheets and other documents and conferencing systems commonly provide for file sharing enabling remote conferees to view and download the computer data files containing graphical and textual data that is utilized in or relevant to the conference. In addition, the conferencing system may provide for application sharing enabling a remote conferee to run appropriate application software and edit data files that are related to the conference.

File and application sharing can be problematic and frustrating for users of a conferencing system. Typically, the file systems of computer systems organize files on the basis of a file or directory tree that specifies a unique storage location for the file. A filename or path name specifies the storage location or path to the stored file in terms of one or more hierarchically inclusive directories or folders, an object that has a name and can contain other directories, folders and files, and a file name which must be unique within the directory in which the file is located. Identifying a data file by a unique location enables reliable retrieval of the file by the computer system, but makes it very difficult for a user to retrieve the file if the location of the file is unknown. Locating a file is made even more difficult because the contents of the various directories of the computer system are often hidden from the user. In addition, conferences commonly utilize files that were created by several individuals, often for disparate purposes, and the path names chosen by those individuals may have little apparent or consistent relationship to each other or the subject of the conference. While the computer system may include a search utility to search the contents of the file system for file names or content suggestive of a subject of relevance to the conference, the process can be lengthy and manual inspection of the contents of a large number of files that have been returned by a search may be required to locate an appropriate file.

Once a file to be shared at a conference is identified, the user must establish the permissions or access rights that will govern use of the file by the conferees and others. To avoid making all of the user's files public, the files to be used with the conference are commonly copied to a new directory and then permissions are set to enable the conferees to view and, if enabled, modify the files in the directory. Operating systems commonly require that the same access rights apply to all files in a folder or directory necessitating multiple folders if different individuals are to be granted differing access rights to respective files. Conferees may be members of more than one group and it may be desired to limit access to a file to certain members of certain groups. The creation of multiple folders containing files with the same data but different path names and access rights complicates synchronization of files and access control. File and application sharing can increase the setup, scheduling and follow-up time required for the conference's organizer, frustrate the organizer and other participants in the conference, and may require intervention by personnel with specialized computing skills.

What is desired, therefore, is a data file management system for a conferencing system that enables conferees to easily locate files for use in a conference and establish the conditions of use of those files by the conference participants and others.

### BRIEF DESCRIPTION OF THE DRAWINGS

FIG. 1 is a block diagram of an embodiment of a conferencing system.

FIG. 2 is a block diagram of a conferencing interface device.

FIG. 3 is a block diagram of a conferencing interface device illustrating processing of audio and video streams by a media framework.

FIG. 4 is a block diagram of a conferencing interface device illustrating recording of audio and video streams with a media framework.

FIG. 5 is a block diagram of the conferencing system illustrating user authentication by the conferencing system.

FIG. 6 is an illustration of a graphical user interface for the conferencing system.

FIG. 7 is an illustration of a graphical user interface to enable a user to arrange a conference.

FIG. 8 is a flow diagram of a process of entering and leaving a conference.

FIG. 9 is a block diagram of the conferencing system illustrating a participant's entry to a conference.

FIG. 10 is an illustration of a moderator's conference control panel.

FIG. 11 is an illustration of a conference control panel for a non-moderating conference participant.

FIG. 12 is a block diagram illustrating the conferencing system during a conference.

FIG. 13 is a schematic illustration of a header for an HTML document that includes descriptors.

FIG. 14 is a block diagram of a first embodiment of a search for file descriptors by an operating system of a conferencing system.

FIG. 15 is a block diagram of a second embodiment of a search for file descriptors contained in a database.

FIG. 16 is a flow diagram of a method for controlling access to a file contained in a file system for a conferencing system.

### DETAILED DESCRIPTION OF PREFERRED EMBODIMENTS

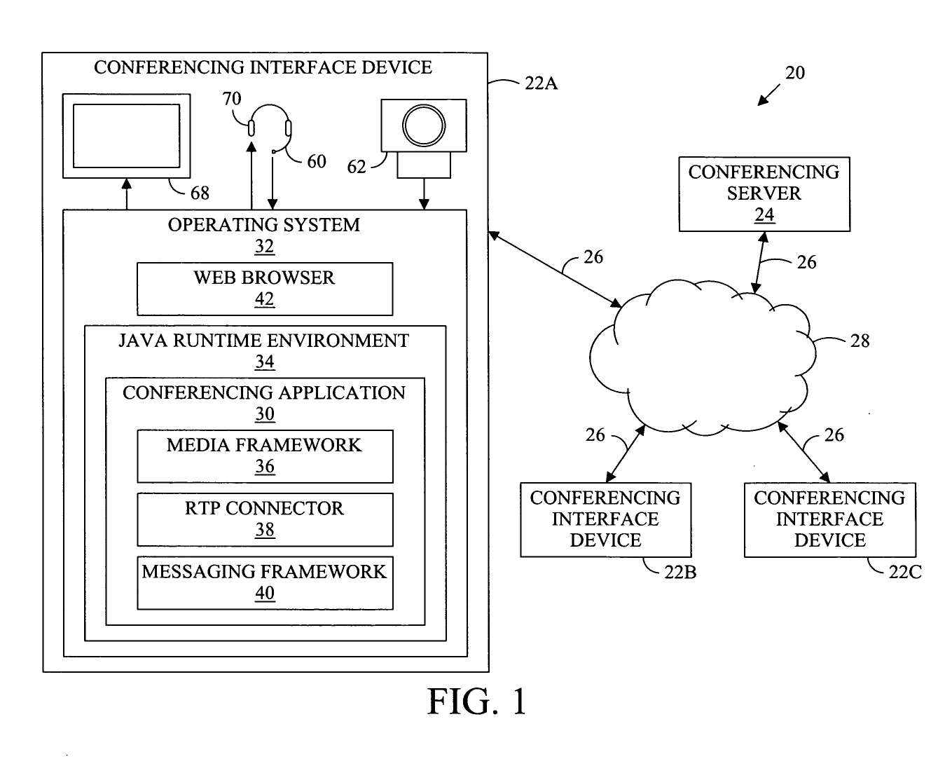

Referring in detail to the drawings where similar parts are identified by like reference numerals, and, more particularly to FIG. 1, a remote conferencing system 20 comprises a plurality of remotely located, user operated, conferencing interface devices 22a, 22b, 22c that are communicatively interconnected. A conferencing interface device is a source or a sink of the audio, video and/or textual data comprising a conference and represents a conference location where one or more conference participants or conferees can participate in a conference. The conferencing interface devices may be interconnected as a plurality of peers that simultaneously function as both a “client” and a “server” to the other nodes of a network of conferencing interface devices. However, the conferencing interface devices are commonly communicatively interconnected through a conferencing server 24 with the interface devices acting as clients sending requests to the server and receiving information from the server. The communication links 26 between users may comprise portions of a local area network (LAN) within a facility and/or a wide area network (WAN) that commonly includes the Internet 28, a global network of communicatively interconnected computing systems.

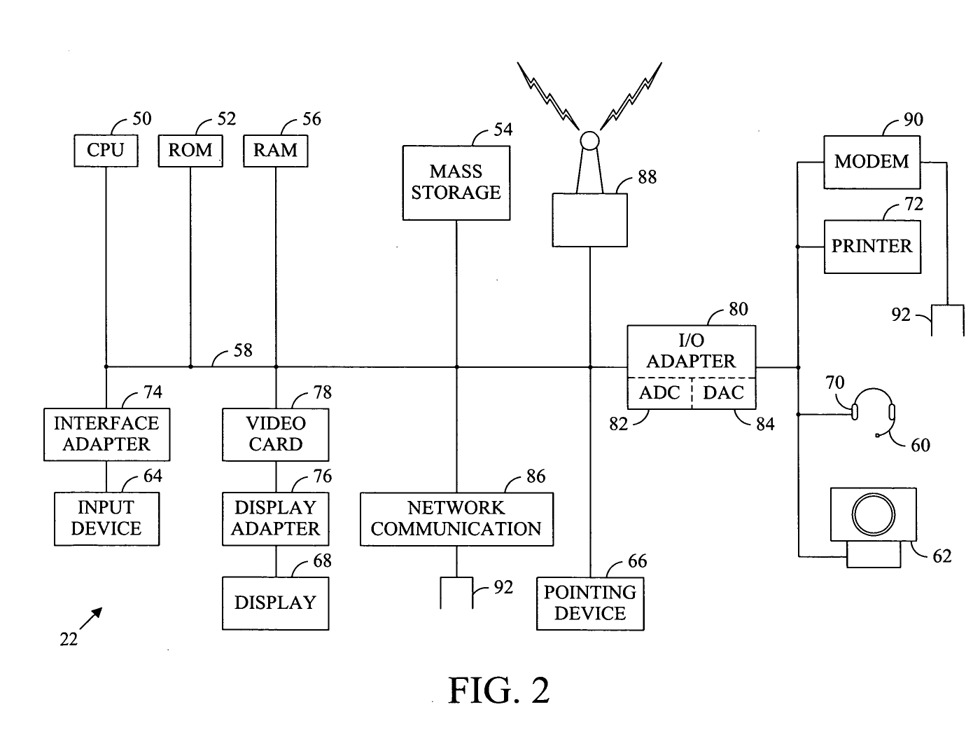

A user's interface with the conferencing system typically comprises a personal computer but may comprise other types of computing devices, such as, personal digital assistants (PDA) or cellular telephones, that are capable of connecting to and communicating over a computer network as a node or client in a peer-to-peer, server mediated or client mediated network. Referring to FIG. 2, a conferencing interface device 22 typically comprises a microprocessor-based, central processing unit (CPU) 50 that fetches data and instructions, processes the data according to the instructions, and stores or transmits the results to an output device or another data processing device. Typically, basic operating instructions used by the CPU 50 are stored in nonvolatile memory or storage, such as a flash memory or read only memory (ROM) 52. Instructions and data used by application programs, including a conferencing application program, are typically stored in a nonvolatile mass storage or memory 54, such as a disk storage unit or a flash memory. The data and instructions are typically transferred from the mass storage 54 to a random access memory (RAM) 56 and fetched from RAM by the CPU during execution. Data and instructions are typically transferred between the CPU and the mass storage over a system bus 58.

The conferencing interface device may also include a plurality of attached input/output (I/O) devices and other peripheral devices. Input devices may include an audio capture device 60, such as a microphone, a video capture device 62, such as a digital video camera, a keyboard 64 for textual input and a pointing device 66, such as a mouse, a trackball or a touch screen display. Output devices commonly include a display 68 for rendering video, text and other visual information, headphones 70 or speakers for audio output and a printer 72 or plotter to render hard copies of documents and images. Under the control of the CPU, data is transmitted to and received from each of the attached devices over a communication channel connected to the system bus 58. Typically, each device is attached to the system bus by way of an adapter, such as an interface adapter 74 providing an interface between the keyboard 64 and the system bus. Likewise, a display adapter 76 commonly provides an interface between the display 68 and a video card 78 that processes video data under the control of the CPU and is communicatively connected to the system bus. The printer 72 and similar peripheral devices are typically connected to the system bus by one or more input-output (I/O) adapters 80 commonly including an analog to digital converter (ADC) 82 and a digital to analog converter (DAC) 84.

The conferencing interface device 22 also includes communication facilities for communicatively interconnecting with other data processing devices including the conferencing server and other conferencing interface devices. These facilities may include a network interface card 86 or circuitry, and/or one or more modems 90 including ports 92 for connection to a telephone system or a wired network. In addition, the conferencing interface may be equipped with a wireless data transceiver 88 for wireless connection to the communication network. The communications facilities provide communication links 26 enabling connection to and communication with one or more computer networks such as a wide area network (WAN), commonly including the Internet, or a local area network (LAN), as appropriate at the user's location.

The conferencing interface device 22 also comprises a conferencing application program 30 that is typically stored in the device's mass storage. In a preferred embodiment, the conferencing application 30 is a JAVA® language-based program which runs in the operating system 32 of the conferencing interface device. The Java Runtime Environment 34, the software required to run a Java language application, initiates the conferencing application program and passes application specific arguments between the application program and the operating system. The conferencing application 30 initiates and configures a media framework 36, a program or programs that enable capture, playback, streaming and transcoding of data streams for audio, video and other time-based media. The media framework captures audio and video data from the audio 60 and the video 62 capture devices and encodes the data in formatted data packets for transmission over the computer network. In the preferred embodiment the media framework comprises the Java Media Framework (JMF) but other methods and protocols could be used to capture audio and video, code, decode and render the audio and video content of a conference.

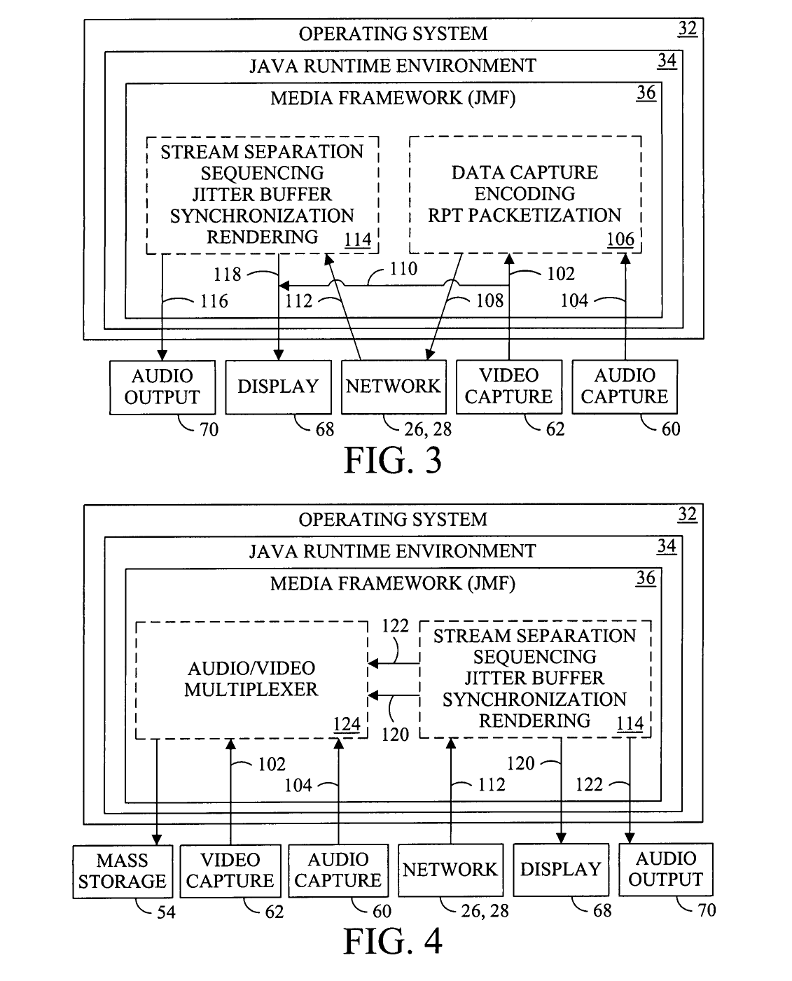

Referring to FIG. 3, the media framework 36, preferably the Java Media Framework (JMF), is a set of tools in the JAVA Runtime Environment 34 which works in conjunction with the operating system 32 of the conferencing interface device. JMF together with other JAVA language tools such as the SWING software tool; a library of controls, such as checkboxes, sliders and virtual buttons, for a graphical user interface; and the WEBSTART software tool, software that facilitates downloading and updating software from the worldwide web, enables encoding, recording and rendering audio and video data streams. Video and audio data is, respectively, captured by a video capture device 62 and an audio capture device 60. The captured video stream 102 is duplicated by the media framework and one copy of the video data stream and the audio data stream 104 are encoded and packetized 106 as Real-Time Transport Protocol (RTP) packets for transmission 108 over the communication network 26, 28 of the conferencing system. Another copy of the video stream 112, captured by the video capture device, is not packetized but is sent to the video display 68 of the conferencing interface device for local display on a graphical user interface of the conferencing system. A transport stream 112 comprising audio and video data is separated into respective audio and video streams, sequenced and synchronized 114. The audio stream 116 and the video stream 118, combined with the locally captured video stream 110 are transmitted to the, respective, audio output device 70 and display 68 for rendering.

The media framework preferably formats the data packets of the captured audio and video data streams according to the Real-Time Transport Protocol (RTP). RTP is an Internet protocol for transporting real-time data, including audio and video. RTP provides end-to-end network transport functions; such as timing, reconstruction, loss detection, security and content identification, suitable for applications, such as audio and video, comprising real-time data transmitted over unicast or multicast communication networks. The data transport function is augmented by a control protocol (RTCP), that allows monitoring of data delivery in a manner scalable to large multicast networks. Unicast refers to a transmission from a single source to a single destination and multicast refers to a transmission from a single source to a subset of all destinations capable of receiving the transmission. The formatted data packets are forwarded to an RTP connector 38 for transmission by the conferencing interface device's communication facility. The RTP connector 38 also receives RTP formatted data from the computer network through the conferencing interface device's communication facility and forwards the data to the media framework where the data stream is depacketized and decoded for rendering. The RTP formatted data received from the communications facility includes data generated by other users or conference participants, represented by conferencing interface devices 22b and 22c.

Referring to FIG. 4, the media framework also provides for recording of the audio and video content of a conference. The transport stream 112 from the communication network 26, 28 is separated into individual audio 122 and video 120 streams which are sequenced and synchronized 114. The resulting video and audio data streams are transmitted to the display 68 and the audio output device 70 for rendering. The audio and video streams are also transmitted to an audio/video multiplexer 124. The multiplexer, which may also receive the local video capture 102 and audio capture 104 data streams, combines the data streams and translates the data to a video file format, such as the QUICKTIME® video file format, which can be saved to mass storage 54 to record the conference.

The conferencing interface device 22 also preferably includes a messaging framework 40 for sending and receiving messages to and from other participants in a conference. The messaging framework, preferably, delivers messages, defined by the conferencing application program 30, to participants who are present in the conference but, because a conference is a dynamic, real-time activity, does not typically store messages. In the event of a late entry to the conference, the messaging framework of the late-arriving conferee's conferencing interface device transmits a message to the other participants in the conference requesting the status of the participants. A conference participant's receipt of a message indicating the entry of a new participant in the conference triggers a response identifying the recipient and describing the recipient's current status.

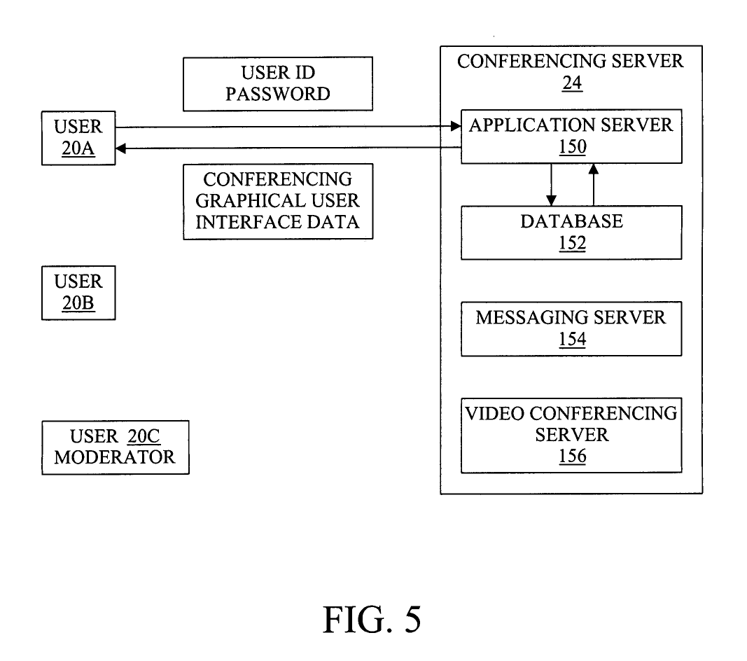

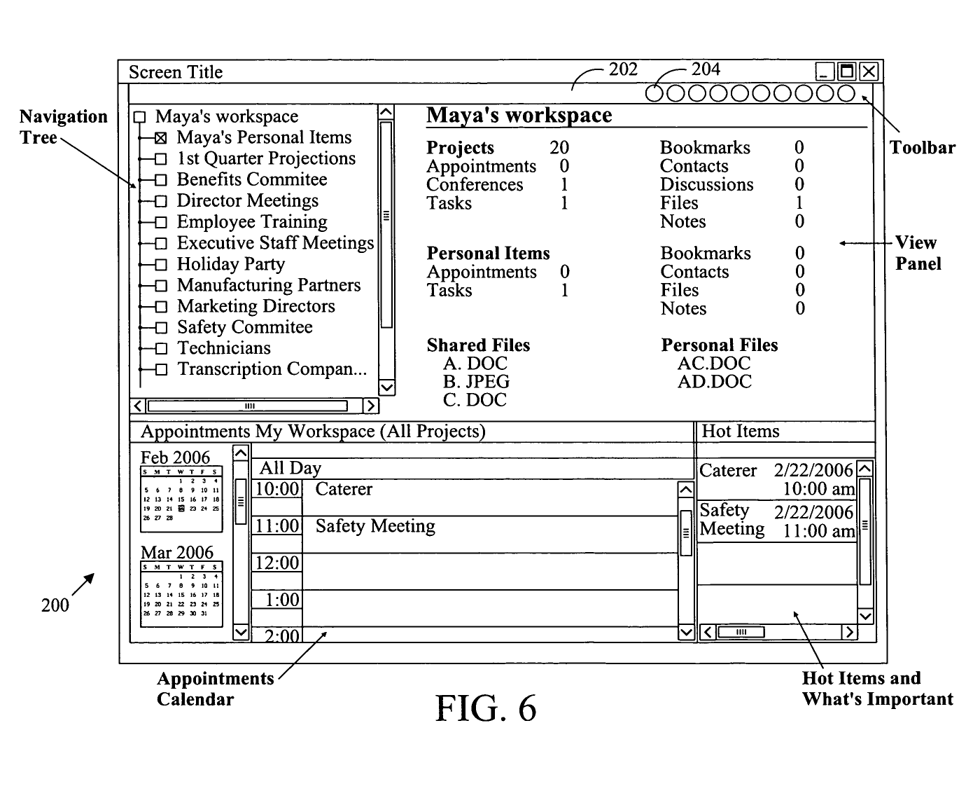

A user can access the conferencing system 20 by entering a user name and password on a portal web page that is displayable with a web browser program 42 on the user's conferencing interface device 22. Referring to FIG. 5, the user name and password are transmitted to the conferencing server 24 and, more specifically, an application server 150. The application server queries a conferencing database 152 to verify that the user name and password entered by the user are registered for the conferencing system. If the user name and password are included in the conferencing system database, the application server obtains user data; including, for examples, the user's name, team members and projects; from the database and returns the user data to the conferencing interface device. Referring to FIG. 6, utilizing the user data, the conferencing interface device renders a conferencing system graphical user interface (GUI) 200 on the display 68 of the interface device. The conferencing system graphical interface 200 enables a user to organize and schedule tasks, conferences and appointments related to projects with which the user is associated. The conferencing system graphical interface also includes a toolbar 202 comprising a plurality of virtual buttons 204 enabling the user to add, delete and otherwise change scheduled activities.

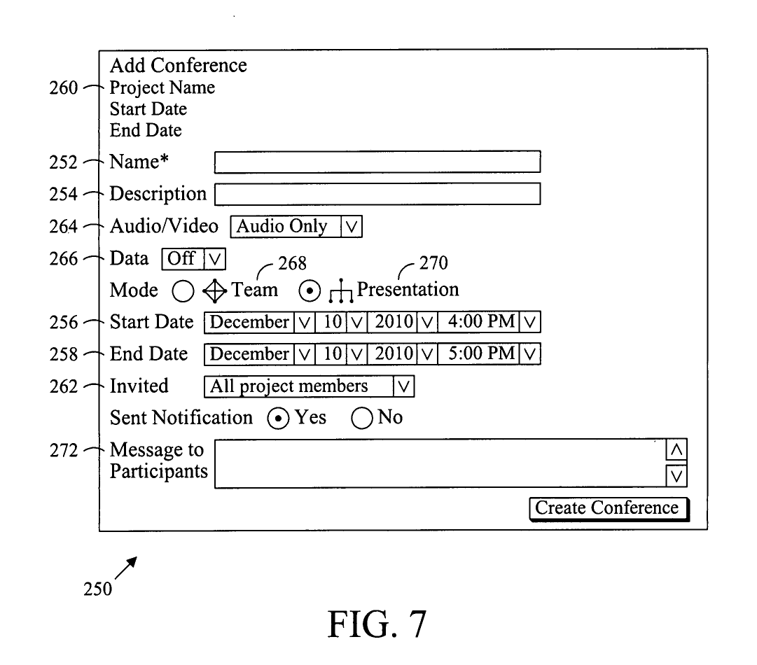

A user authorized to access the conferencing system can schedule a conference from the conferencing system graphical interface 200 displayed on the user's interface device. Referring to FIG. 7, by selecting one of the virtual buttons 204 of the toolbar 202 of the graphical interface 200, the user can cause the conferencing interface device to display an add-conference interface 250. The add-conference interface enables entry of a name 252 for a conference, a description of the conference 254, and the starting 256 and ending 258 times of the conference. The user can also associate the conference with the name of one of the projects with which the user is associated 260 and, using a drop down menu, invite all or some of the members of the project team 262. The user can also select whether the conference will utilize neither audio nor video, audio alone or both audio and video 264. Audio and video may not be necessary or desirable during a data sharing conference and, if bandwidth is limited at a conference location or if the number of conference locations is large, it may be necessary to confer by audio only. The conference scheduler can also select whether data sharing tools 266, such as file sharing and whiteboard, will be in use during the conference.

In addition, the add conference interface 250 enables the user scheduling a conference to select a mode for the conference. The conferencing system enables a team mode 268 in which all conference participants can simultaneously transmit and receive audio, video and data, to the extent that audio, video and data transmission is enabled for the conference. Since the team mode requires transport streams containing audio, video and, in many cases, data from each of the conference locations, the number of locations from which participants can transmit is often limited by the bandwidth required for transmission of the multiple data streams. In the presentation mode 270, audio and video is transmitted primarily by a single individual while the remaining participants watch and listen. If permission is granted by the conference moderator, one or more of the other conferees may transmit audio and/or video. The presentation mode limits the number of locations that are simultaneously transmitting and, commonly, limits transmission, from users other than the moderator, to audio. The bandwidth required for a conference in the presentation mode is typically less than the bandwidth required for the team mode allowing larger numbers of conference locations. When the presentation mode 270 is selected, the conferencing system designates the user scheduling the conference as the conference moderator. From the add-conference interface, the scheduler of the conference can designate who will be invited to the conference and send notification to the invitees with a message 272, if desired. When the conference's configuration has been specified by the scheduler of the conference, a conference configuration, including name, description, time and names of invitees, is transmitted to the application server and stored in the conferencing system database 152. The conferencing server transmits an invitation and any associated message to each of the conference invitees.

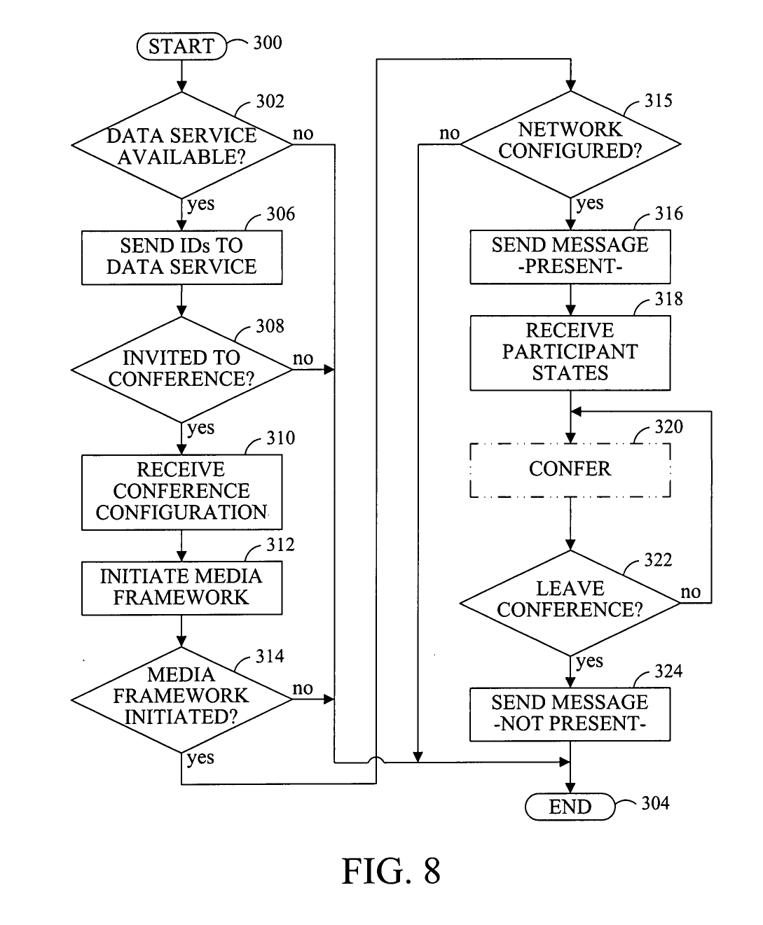

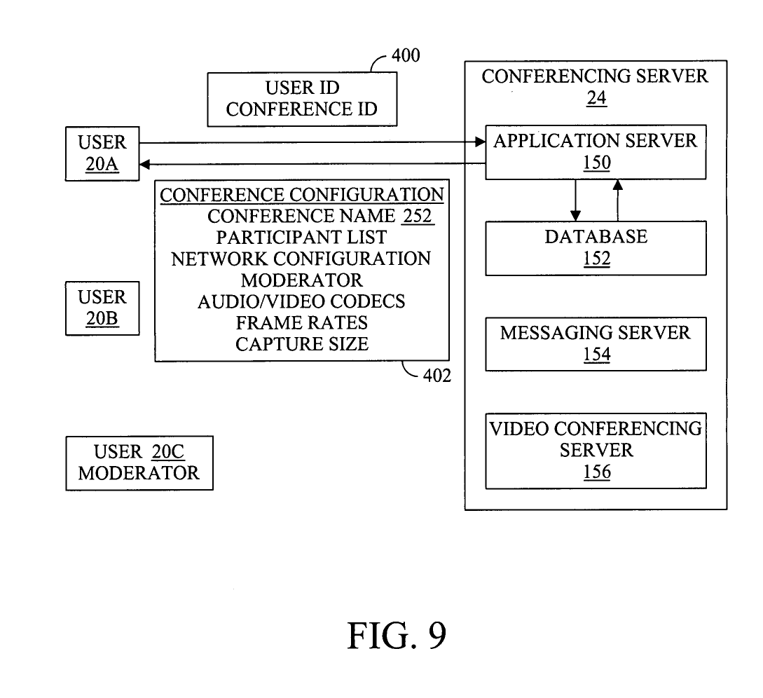

Referring to FIG. 8, to participate in a conference, the conferencing application is initiated 300 on a user's conferencing interface device, for example conferencing interface device 22a. The interface device connects to the conferencing server 24 and determines if data services, such as the messaging server 154, are available 302. If the data services are not available, the application exits 304. Referring to FIG. 9, if the data services are available, the user's identification, such as the user's username and password, and a conference identifier 400 are transmitted by user's conferencing interface device to the conferencing server and more specifically to the application server 306. The application server checks the database and determines if the user is invited to the conference 308. If the application server does not confirm the user's invitation to the conference, the conferencing application exits 304. If the identified user is a conference invitee 308, the application server transmits conference configuration data 402, stored in the conferencing system database 152, to the user's conferencing interface device. The conference interface device utilizes the conference configuration data; comprising the conference name 252, participant list, communication network configuration, moderator identity, audio and video coder and decoder identification; received from the conferencing server 310 to configure the relevant systems of interface device to enable entering and participating in the conference.

In response to receiving the conference configuration data, the conferencing application initiates the media framework 314 which attempts to enable the respective devices and systems of the interface device, as required by the conference configuration, to capture, transmit, receive and render conference video, audio, and data. For examples, a participant, typically, must be able, at least, to receive and render audio and the moderator of a conference must be, at least, able to transmit audio. If the media framework cannot be initiated or any required medium capture or rendering device enabled, the conferencing application exits 304.

If the required data capture and rendering systems are successfully enabled, the conferencing application attempts to configure any required network resources 315. For examples, the conferencing application attempts to contact the messaging server 156, join conference multicast groups and establish a socket connection to any video conferencing servers required by an RTP connector. To participate in a conference comprising audio and video, the conferencing interface device creates four TCP (Transmission Control Protocol) sockets for communication between the user interface device and the video conferencing server 156. The TCP sockets, comprising an Internet Protocol address and a port number, are endpoints for communications between the server and the user interface device. A TCP socket is established for each of video RTP communication, video RTCP communication, audio RTP communication and audio RTCP communication. The RTCP sockets enable communication of control information associated with transmission and reception of RTP data packets. RTCP provides for counting lost packets, measuring jitter and other housekeeping duties defined by the RTP protocol. If the conferencing application cannot configure the required network resources, the conferencing application exits 304.

If the required network resources are successfully configured a PRESENT message is transmitted to all conference participants 316 and the user, represented by the conferencing interface device 20a, enters the conference. The PRESENT message is transmitted to the messaging server 154 by the messaging framework 40 of the conferencing interface device. Preferably, the messages transmitted and received by the messaging framework are propagated using Jabber communication protocols. Jabber is an open XML (extensible Markup Language) protocol for instant messaging. In response to receipt of the PRESENT message from the newly entering conferencing interface device, the messaging server 154 transmits the PRESENT message to all of the previously entered participants in the conference and transmits the list of current participants to the newly entering conferencing interface device. The messaging framework of the newly entering conferencing interface device transmits a unicast message to all of the current participants in the conference requesting that the participants acknowledge the newly entering participant by transmitting current status data for the respective participant.

Preferably, each participating conferencing interface device maintains its own state data, specifying; for examples, without limiting possible state data, the current conference identification, whether the conferencing interface device is the moderator of a presentation conference, whether the conferencing interface device has permission to transmit audio, and whether the conferencing interface device is transmitting video. When a participant receives a message from the messaging server, the respective user interface device responds by transmitting its current state data to the newly entered participant and, if required by the conference mode, configures itself to receive an additional data stream from the new conference participant. During the conference, the state data of the respective participants may change, for example, permission to transmit audio may be granted to a conferencing interface device participating in a presentation type of conference or a conference participant may leave the conference. As required, the messaging server 154 transmits messages to the messaging framework of each current participant advising the participant of a change in the status of another participant.

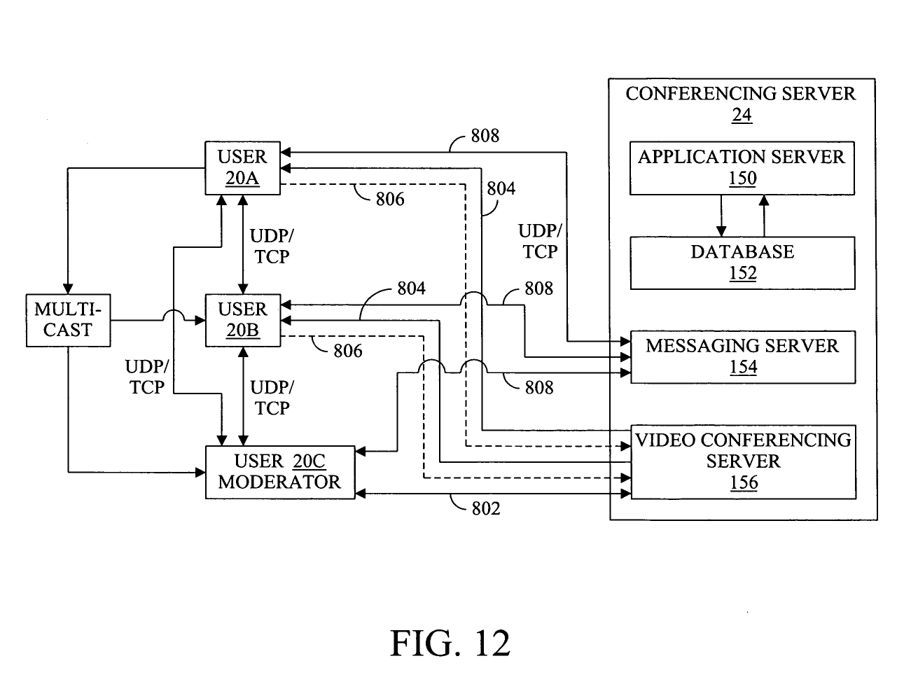

Once the information regarding the conference participants has been received 318, the conferencing interface device begins rendering the conference's audio and video streams 320. Referring to FIG. 12, when the TCP sockets are established, the conferencing interface device will be able to transmit and receive video and audio through the video conferencing server 156. In the presentation mode, the moderator 22c can transmit and receive video and audio 802 from the video conferencing receiver 156 while the other participants are commonly limited to receiving audio and video 804 from the video conferencing receiver. If a participant, other than the moderator, wishes to transmit, the participant must request permission from the moderator and transmission is usually limited to audio 806. The video conferencing server 156 is typically capable of handling a plurality of independent conferences each with multiple participants. All participants can transmit messages to and receive messages from the messaging server 808. The conferee continues to participate in the conference until the user elects to leave the conference or the conference ends 322. If the user leaves the conference or the conference ends, a NOT PRESENT message is transmitted 324 by the messaging framework of the conferencing interface device and the conferencing application terminates 304.

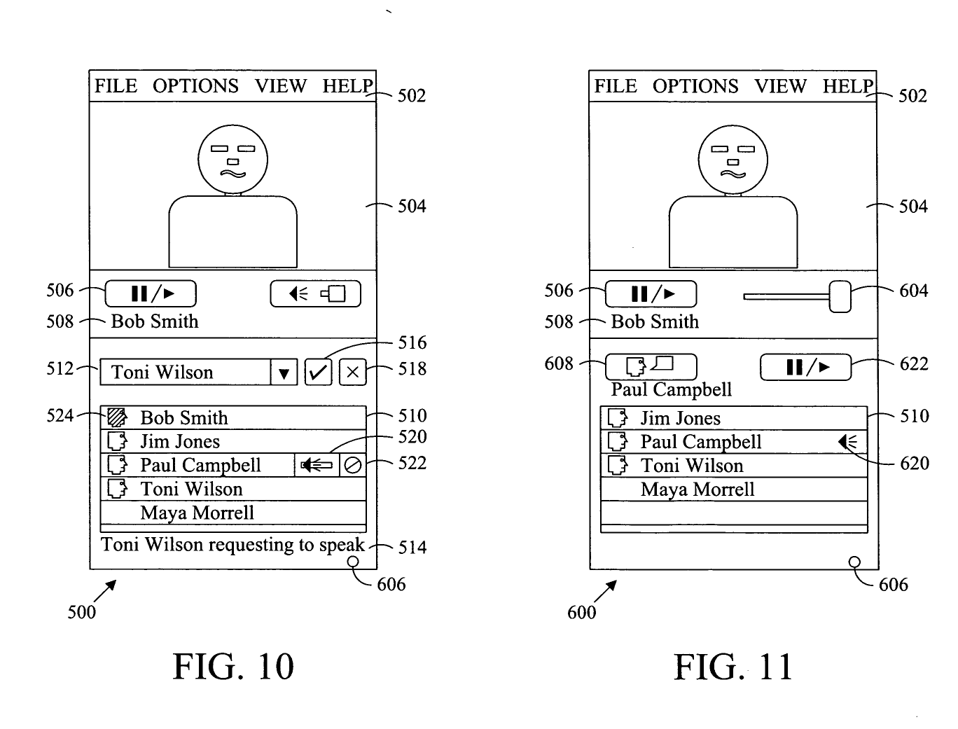

In the presentation mode, the conference host and moderator is the presenter and the other participants are generally passive listeners and viewers of the host's audio or video and audio presentation. Referring to FIGS. 10 and 11, respectively, during a presentation mode conference, the conferencing interface device of the conference moderator displays a moderator's conference console 500 and the conferencing interface device(s) of other conference participants display a conferee conference console 600. The conference consoles 500, 600 present menu options from a menu bar 502, including drop down menus enabling the moderator to start and stop transmission and record the conference. The moderator or another conference participant may also view conference information, participant properties and reception statistics through drop down menus rendered in response to selection of one of the choices on the menu bar.

Video of the moderator is displayed in a viewing pane 504 during a presentation mode conference. Conference participants can toggle the video display of the moderator on or off by selecting and actuating a video toggle button 506 below the viewing pane. If the conference does not include video, no image is displayed in the viewing pane. The name of the presentation mode conference moderator 508 is displayed below the viewing pane with an audio volume slider 604 permitting the user to adjust the volume of the moderator's audio transmission. The moderator may initiate recording of the conference from a drop down menu in the menu bar and, in some embodiments of the conferencing system, other participants may also record the conference. A recording indicator 606 on the conferee conference console changes state to indicate when the conference is being recorded.

The names of the invitees to the conference are displayed in a participant panel 510 below the viewing pane. An invitee's presence in the conference is indicated by an icon 512 which is displayed proximate the invitee's name when the participant enters the conference.

File sharing enables remote conferees to download and view documents, photographs and other textual and graphical material and application sharing permits a remote user to run appropriate application software and remotely edit shared files. Conferencing is substantially facilitated when remote conferees can view and edit documents and other files that are related to a conference. However, file and application sharing can be frustrating for users of a conferencing system because it is often difficult to locate the appropriate files particularly when the computer system includes a large number of files. Further, once files to be shared are located it can be difficult to grant others the desired access to the files.

Typically, the files included in a computer system are identified by a filename or path name that specifies a hierarchical tree of inclusive storage locations identifying the storage location of the specific file in the computer's mass storage. For example, a path name may specify a physical or virtual mass storage device as a primary or root directory, an object that has a name and can contain other directories and folders. The primary or root directory may include one or more directories or folders which, in turn, contain one or more directories or folders, etc. The path name concludes with a file name which must be unique in the directory or folder in which the file is stored. An index to a file allocation table associating of the path name with the physical storage location of the file enables reliable retrieval of the file by the computer.

While the unique path name enables reliable file retrieval by the computer, locating a file can be difficult for the computer's user. To locate the file, a user must know the path name, the hierarchy of directories and folders beginning with the primary or root directory and ending with the file name, that specifies the file's location. If the user does not know the path name, the file system can be manually searched for the file(s) of interest. However, such searching is difficult because the contents of directories are usually hidden from the user and, if the files are created by several persons, there may be little consistency in the naming or storing of files. Locating a file or files for sharing in a conference becomes increasingly difficult as the number of files stored on the computer increases. If unable to locate a file with a manual search of the files stored on the computer system, the user may use a search utility to search for a file's name or to search the contents of files for specified words. However, this can be a time consuming process because the search can lengthy, particularly when the file system is large, and a manual investigation of the contents of a substantial number of files identified by the search may still be required to locate the desired file.

Once a file to be used in a conference is located, the user must establish permission or access rights to the file for the conference participants and, if applicable, others to enable them to view and, if permitted, edit the file. Granting access to a file used in a conference can be a laborious and frustrating process. Operating systems are commonly designed so that the same access rights must be granted for all files in a folder or directory. A file to be used in a conference is commonly copied into a new directory so that the other conference participants can be granted permission or access rights to share the file without granting access rights to other files stored on the computer system. Typically, directories, programs, folders or files are referenced to an access control list, usually a table specifying the access rights of individuals or groups to specific objects, for example a file to be shared in a conference. The object's owner, typically the originator of the object, or an authorized administrator of the computer system can determine specific access rights to the object, such as whether others can read from, write to or execute the object. Since common access rights must be granted to all users having access to a folder, if different access rights are to be granted for one or more files used in a conference these files must be placed in separate folders. A user of the conferencing system may be a member of many different groups, each comprising different members, and it may be desirable to only share the file with certain groups, subgroups or individuals. Setting permissions granting appropriate users the desired access to a file can be difficult and may require establishing several folders each including a subset of the files to be shared and each having different access rights. Consultation with persons having specialized computer training may be necessary because file sharing is complex and often beyond the skill of the conference organizer.

The inventor concluded that a data file management system providing flexible associative access to file content would enhance the usability of the conferencing system and increase user satisfaction with the system by making it easier to locate files for a conference and specify the access to the files that is to be afforded to others. A preferred embodiment of the conferencing system includes a data file management system in which one or more “tags” or descriptors is associated with each file and locating the file and specifying permission or access to the file is enabled through the association of the descriptor or tag and the file.

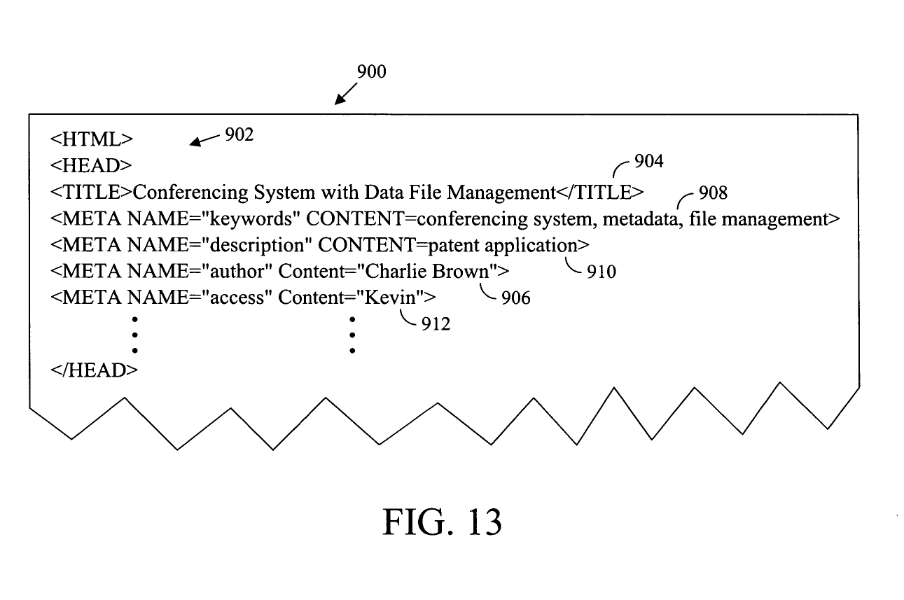

Referring to FIG. 13, a file in the conferencing system 20 may be, for example, associated with one or more descriptors or tags that are descriptive of the file. Descriptive tags may include, by way of examples, a title for the file 904, an abstract, the name of the originator 906 or keywords from the files content 908, such as “boat,” “automobile,” “school” or “Rebecca.” In other cases, descriptive tags provide a classification for the file 910, such as “budget” for budget related files, “$$” for investment related files, “college” for files related to education or “patent application.” Tags may also be administrative in nature indicating, for examples, when the file was created, the file type and the nature and extent of access rights or permissions granted for the file 912.

The descriptors may be automatically generated when the document is created or changed or the descriptors may be manually generated by a user. For example, the name of the user generating the file is likely to be saved by the computer system when the file is created. On the other hand, a list of keywords may be automatically generated by the computer by comparing the frequency of occurrence of a word in the text of a file to a statistical likelihood of occurrence in the language, in general, or the originator of the file may provide a list of words that he/she considers to be descriptive of the content of the file.

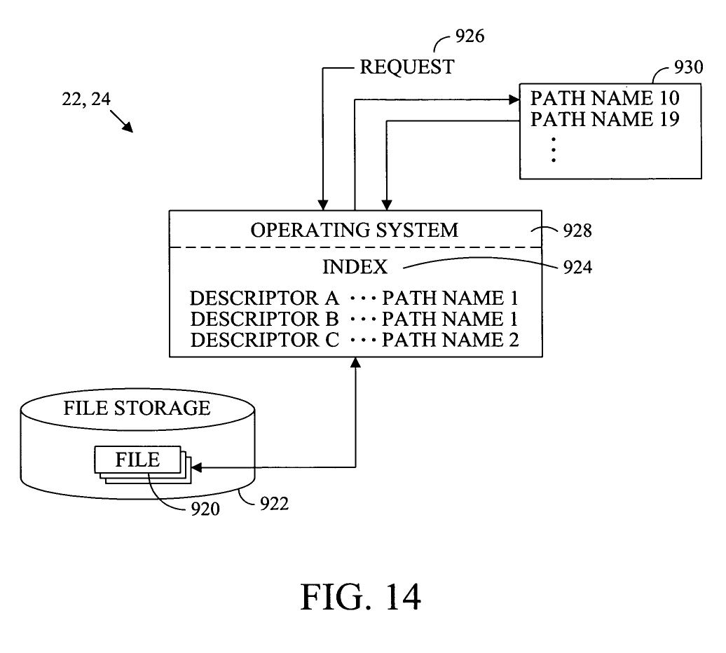

The tags or descriptors may be attached to the file in some meta-data portion of the file and stored with the file data. By way examples, the Hyper-Text Markup Language (HTML), as illustrated in FIG. 13, the eXensible Markup Language (XML) and the Multipurpose Internet Mail Extensions (MIME) provide for the storage of descriptors and other metadata in a header 902 for the document 900 or file. Referring to FIG. 14, when a new file 920 is saved in the file storage 922 of a conferencing interface device 22, the conferencing server 24 or another device in the conferencing system, the operating system reads the descriptors contained in the file and adds the hierarchical filename or path name for the file and the descriptors associated with the file name to a file system index 924. Thereafter, when the file is saved, the operating system will save any changes to the file's descriptors in the index. To locate a document stored in the conferencing system's file storage, a user transmits a request 926 to the conferencing application program of the conferencing interface device which may retransmit the request to the conferencing server. The request includes one or more descriptors which the user associates with the conference and the logical connection between the descriptors. For example, the user may search for a file related to “college” AND authored by “Rebecca.” The operating system 928 searches the index 924 for files having descriptors matching the request and renders a list of files having associated descriptors matching the request. The user may utilize the files consistent with a policy of the operating system or access descriptors associated with the files.

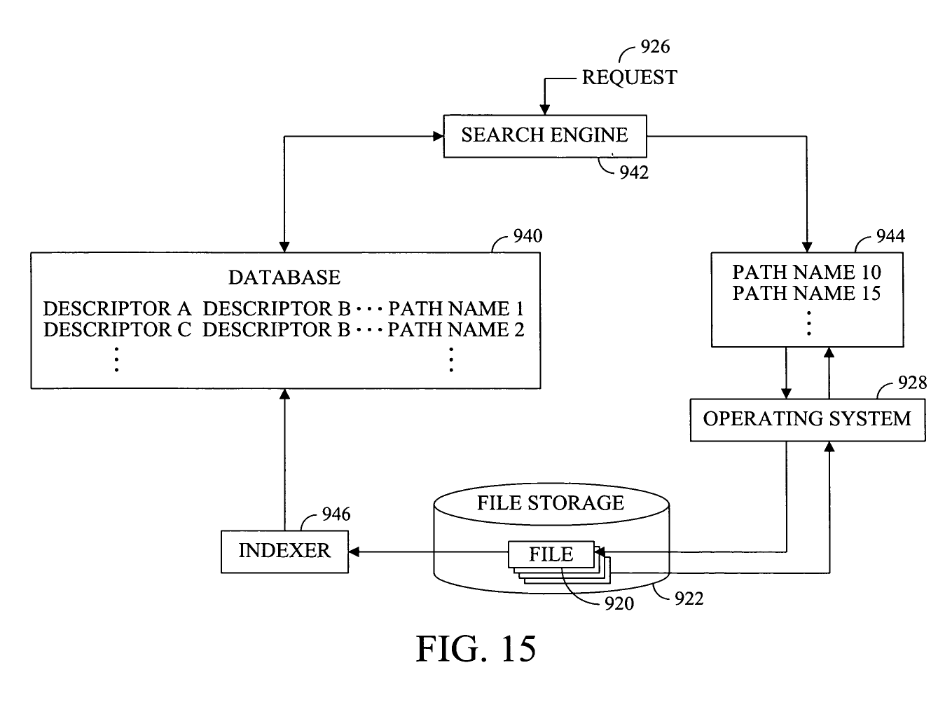

Referring to FIG. 15, on the other hand, the tags or descriptors and their association with the respective file may be maintained in a database 940. To locate a data file, a user transmits a request 926 to a search engine 942 specifying one or more descriptors of interest and a logical relationship of the descriptors, if applicable. For example, the request might seek budget documents related to automobiles for which principals have been granted access rights and, therefore, might, for example, specify descriptors “budget” AND “automobiles” AND “principals”. The search engine translates the request to a query suitable for querying the database, such as Structured Query Language (SQL) and searches the database for files that are associated with descriptors matching the user's request. The search engine returns a listing 944 comprising the file(s) identified in the search. The user can review the list of files returned by the search, select files of interest from the list and cause the operating system 928 to retrieve the files from the file storage for further review or use as permitted by the operating system and access descriptor associated with the file. An indexer 944, similar to a web crawler or spider, periodically examines the files stored in the file storage 922 to identify new files and revised descriptors associated with the files and update the data base.

Descriptors may also be used be used to authorize access to files and to designate the access rights granted. For example, a permission or access descriptor or tag, ACCESS=“teachers,” might identify the file as a file that can be read by the members of the teachers group. On the other hand, ACCESS_WRITE=“principals,” identifies the file as a file that can be viewed and written to or edited by the members of a group called “principals”. In the conferencing system, a permission or access tag authorizing access by a group grants the access rights to all users registered with the conferencing system as members of that group. However, an access tag may authorize access for an individual user, regardless of whether the user is a member of a group or not. For example, the access tag, ACCESS=“kevin,” would enable the user, Kevin, to read the file, but, even though Kevin is registered as a member of a group, would not authorize access to the remaining members of the group. The access tags enable the organizer of a conference to flexibly authorize individual users and members of groups, including groups created for the specific purpose of access to the file, to read and, if enabled by the descriptor, write to files by associating a descriptor with the file or changing a descriptor associated with the file that specifies the identity of the users having access to the file and the level of access afforded to the authorized users.

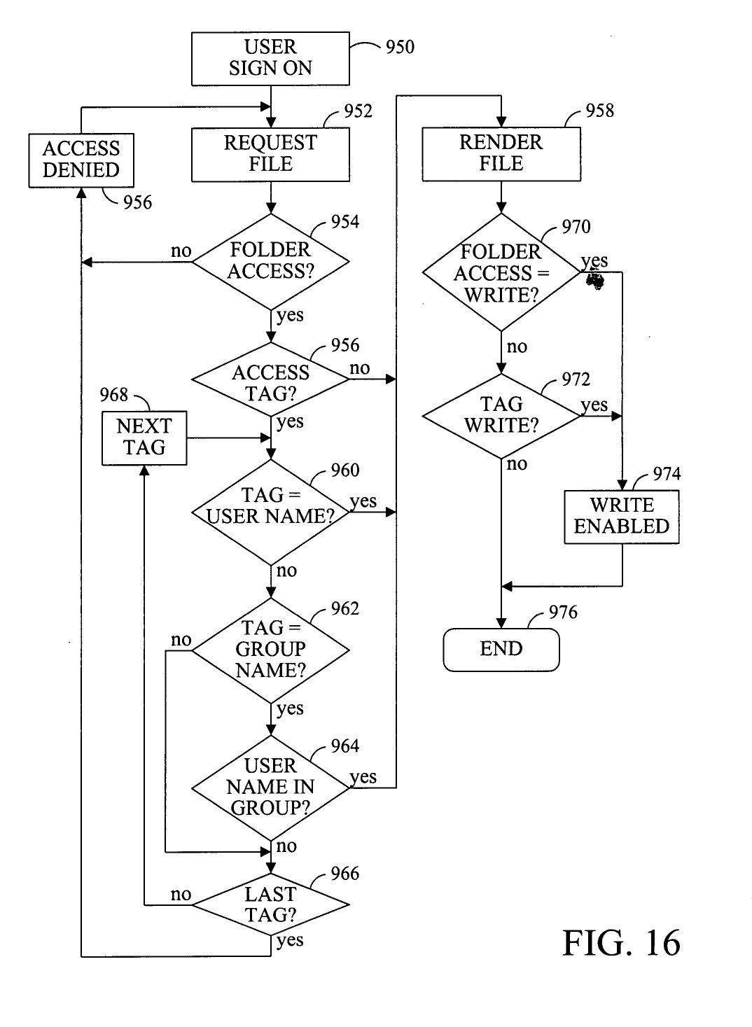

Referring to FIG. 16, a user is identified to the conferencing system when the user logs on to the system 950. Typically, the user is identified individually by a user name and password, but other or additional log in procedures could be utilized. In the conferencing system, participants in a conference and other users of the system are also identified by the groups to which they belong, the identities of which are stored in association with the user's user name. When the user requests access to a file 952, either by searching the descriptors related to files stored on the system, entering a path name or otherwise, the conferencing system determines if the user's access to the folder that contains the requested file is permitted 954. Operating systems commonly provide a means of enabling access to all of the files contained in a folder. Typically, the files used in a conference are placed in one or more folders and access to, at least, read the files is granted to all of the conference participants and may be granted to other select individuals. If the user's access to the folder containing the file is not permitted, access to the file is denied 956. If the requesting user's access to the folder that includes the desired file is authorized 954, the system determines whether the requested file also includes a permissions or access tag or descriptor 956. If the file does not include an access tag or descriptor, access to the file is controlled by the permissions granted for all files included in the folder and the file is rendered 958 for the user to read.

It may be desired to grant disparate individuals or groups differing levels of access or different prerogative to certain files. If the same permission must be granted for all files in a folder, a folder must be created for each subset of access rights and users. However, access rights to individual files can be granted to groups and individuals by providing descriptors identifying the access right and the users that are permitted access to the file. If the file does include an access descriptor, the system determines whether the access descriptor identifies the requesting user as an individual permitted access 960. If the descriptor authorizes the user's access to the file as an individual, the file is rendered for reading 958 by the user.

If the descriptor does not authorize access to the file for the user as an individual, the system determines if the descriptor authorizes access by a group, such as “principals” 962. If a group is authorized the conferencing system determines if the user is registered with the system as a member of the authorized group 964 and, if so, the file is rendered for reading 958. If the file does not include a group authorization or if the user is not a member of an authorized group, the system determines if the current access descriptor is the last access descriptor 968. If the file contains additional access descriptors, the system determines if the user is authorized by the next access descriptor 968. If none of the access descriptors for the document authorize the user's access, either individually or as a member of a group, access to the file is denied 956.

If rendering of the file for reading has been enabled, the conferencing system determines if either the folder access 970 or the descriptor authorizing the user's access 972 to the file authorizes the user to write to the file. If so, writing is enabled, permitting the user to modify the file 974. The process of authorizing access ends 976 when it is determined that writing is not authorized or, if authorized, when writing is enabled.

Typically, tags may be modified by the author of the file or an administrator of the conferencing system. In some cases, files may be provided for a conference in which there is a moderator. In this case, the moderator may likewise have permission to change the access tags to the data files and modify the accessibility of the files for different users. In addition, the moderator may likewise change the users identified by access descriptors associated with the file enabling the moderator to modify the accessibility of the files for different users.

The file system including data file descriptors facilitates locating files in the large filing system of a conferencing system and provides a flexible method of designating which users have permission to access to a file and the level of the authorized user's level of access.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (We) claim:

1. A method of communicating data to a user of a conferencing system, said method comprising the steps of:
(a) associating a descriptor with a file including said data;
(b) storing said descriptor and an association with said file;
(c) retrieving said file by specifying said descriptor; and
(d) enabling said user to access said file.

2. The method of communicating data of claim 1 wherein said descriptor and a name of said file is stored in a database.

3. The method of communicating data of claim 1 wherein said descriptor is stored in said file.

4. The method of communicating data of claim 1 wherein said descriptor comprises a characterization of said data.

5. The method of communicating data of claim 1 wherein said descriptor comprises a classification of said data.

6. The method of communicating data of claim 1 wherein said descriptor comprises an identification of an individual authorized to access said data.

7. The method of communicating data of claim 1 wherein said descriptor comprises a prerogative of said user with respect to said data.

8. The method of communicating data of claim 1 wherein the step of retrieving said data by specifying said descriptor comprises the steps of:
(a) transmitting a request to a computer to search for a file associated with said descriptor; and
(b) identifying a file associated with said descriptor in a database.

9. The method of communicating data of claim 1 wherein the step of retrieving said data by specifying said descriptor comprises the steps of:
(a) transmitting a request to a computer to search for a file associated with said descriptor; and
(b) identifying a file associated with said descriptor in an index of file names and associated descriptors.

10. A method of enabling access to data stored in a file system of a conferencing system, said method comprising the steps of:
(a) associating a descriptor with a data file including said data, said descriptor including an identity of at least one individual to be granted access to said file;
(b) storing said data file in said file system; and
(c) rendering said data if a requester is an individual identified in said descriptor as an individual permitted to access said file.

11. The method of enabling access to data of claim 10 further comprising the step of rendering said data if said requester is a member of a group identified in said descriptor as a group permitted to access said file.

12. The method of enabling access to data of claim 10 further comprising the step of enabling said requester to modify said data if said descriptor identifies said requester as an individual having a prerogative to write data to said file.

13. The method of enabling access to data of claim 10 further comprising the step of enabling said requester to modify said data if said requester is identified as a member of a group identified by said descriptor as having a prerogative to write data to said file.
